(19) United States
(12) Patent Application Publication
(10) Pub. No.: US 2006/0010167 A1
(43) Pub. Date: Jan. 12, 2006

(54) Apparatus for navigation of multimedia content in a vehicle multimedia system

(76) Inventors: James R. Grace, Royal Oak, MI (US); Robert M. Riley JR., Albuquerque, NM (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 11/172,381

(22) Filed: Jun. 30, 2005

Related U.S. Application Data
(63) Continuation-in-part of application No. 11/036,213, filed on Jan. 14, 2005.
(60) Provisional application No. 60/538,043, filed on Jan. 21, 2004.

(51) Int. Cl. G06F 17/00

(52) U.S. Cl. 707/104.1

(57) ABSTRACT

Apparatus are provided for navigation of multimedia content in a vehicle multimedia system having an embedded database of multimedia files. A navigation interface for controlling playback of the multimedia files and includes a processing unit, an input unit coupled to the processing unit, and a display coupled to the processing unit. The processing unit is configured to couple with the embedded database, determine a playback frequency for each of the multimedia files, and generate a playlist of multimedia files based on the playback frequency. The input unit is configured to initiate playback of the playlist. The display is configured to display the playlist.

### CROSS-REFERENCE TO RELATED APPLICATION

This application is a continuation-in-part of US Ser. No. 11/036,213 filed Jan. 14, 2005, which claims the priority of U.S. Provisional Ser. No. 60/538,043 filed Jan. 21, 2004.

### TECHNICAL FIELD

The present invention generally relates to multimedia systems for a motor vehicle, and more particularly relates to apparatus for navigating the multimedia systems.

### BACKGROUND

Vehicle operators tend to spend a significant amount of time in their vehicles particularly when commuting from a home to a workplace, running errands, conducting business, vacationing, or for many other reasons. This time is significant enough that some vehicles come equipped with a variety of consumer electronics such as compact disc (CD) players, cassette tape players, radios, satellite radios, electronic gaming, and digital video disc (DVD) players. Some owners may also choose to equip their vehicle with aftermarket consumer electronics in the event their vehicles lack such consumer electronics or for purposes of customization. These and other entertainment or infotainment electronic devices provide a passenger in the vehicle with time-occupying options and may improve the passenger's quality of time.

Consumer electronics such as CD players, cassette tape players, DVD players, and electronic gaming generally have related media content for playback residing on a localized storage medium. For example, many on-board navigation systems utilize geographic information stored on CDs. This information may be downloaded to a memory specifically associated with the navigation system, located in the vehicle, or directly accessed from the CD by the navigation system. In another example, CD players commonly play media that is stored on CD. Most of these playback devices can accept a limited number of storage media during operation and thereby generally have a relatively limited capacity of media selection. For example, a CD player with a six-disc CD changer has a selection of music tracks that are limited to any six CDs contained in the CD changer.

With multimedia that is stored on various mediums, such as CD or DVD, digital rights management (DRM) has become prominent. For example, many performances that are recorded onto CDs are copyright protected. Additionally, access to such recordings may be limited to certain types of playback devices in an attempt to prevent unauthorized duplication of the recordings. For example, some CDs may be limited to playback on a conventional stand-alone CD player having a read-only operation but not on a CD drive found to accompany personal computers where unauthorized duplication may occur.

Accordingly, it is desirable to provide an infotainment system for a vehicle that stores a variety of multimedia files on an embedded storage device while preserving DRM. It is further desirable to provide a vehicle multimedia data storage and transfer system having a navigation interface that is simple to use and that may be content oriented. Finally, other desirable features and characteristics of the present invention will become apparent from the subsequent detailed description and the appended claims, taken in conjunction with the accompanying drawings and the foregoing technical field and background.

### BRIEF SUMMARY

Apparatus are provided for navigation of multimedia content in a vehicle multimedia system having an embedded database of multimedia files. In one exemplary embodiment, a navigation interface is provided for controlling playback of the multimedia files and includes, but is not limited to, a processing unit, an input unit coupled to the processing unit, and a display coupled to the processing unit. The processing unit is configured to couple with the embedded database, determine a playback frequency for each of the multimedia files, and generate a playlist of multimedia files based on the playback frequency. The input unit is configured to initiate playback of the playlist. The display is configured to display the playlist.

In another exemplary embodiment, a navigation interface is provided for controlling playback of the multimedia files and includes, but is not limited to, an input unit configured to select a category of multimedia content, a processing unit coupled to the input unit, and a display coupled to the processing unit. The input unit is configured to couple with the embedded database, detect a selected category of multimedia content, and generate a playlist of multimedia files from the embedded database based on the selected category of multimedia content. The display is configured to display the playlist and the category of multimedia content.

In yet another exemplary embodiment, a vehicle multimedia system is provided including, but not limited to, a database of multimedia files, an input unit configured to select a category of multimedia content, a processing unit coupled to the input unit and the database, and a display coupled to the processing unit. The processing unit configured to generate at least one category of multimedia content, detect a selected category of multimedia content, and select a group of multimedia files for playback from the database of multimedia files based on the selected category of multimedia content. The display is configured to display the category of multimedia content and the selected category of multimedia content.

### BRIEF DESCRIPTION OF THE DRAWINGS

The present invention will hereinafter be described in conjunction with the following drawing figures, wherein like numerals denote like elements, and

FIG. 1 is a schematic diagram of an exemplary embodiment of a multimedia storage and transfer system in a vehicle;

FIG. 2 is a block diagram illustrating communication between components of an electronic vehicle storage system; and

FIG. 3 is a block diagram of an exemplary embodiment of a navigation interface;

FIG. 4 is a front view of a first embodiment of the navigation interface; and

FIG. 5 is a front view of a second embodiment of the navigation interface.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

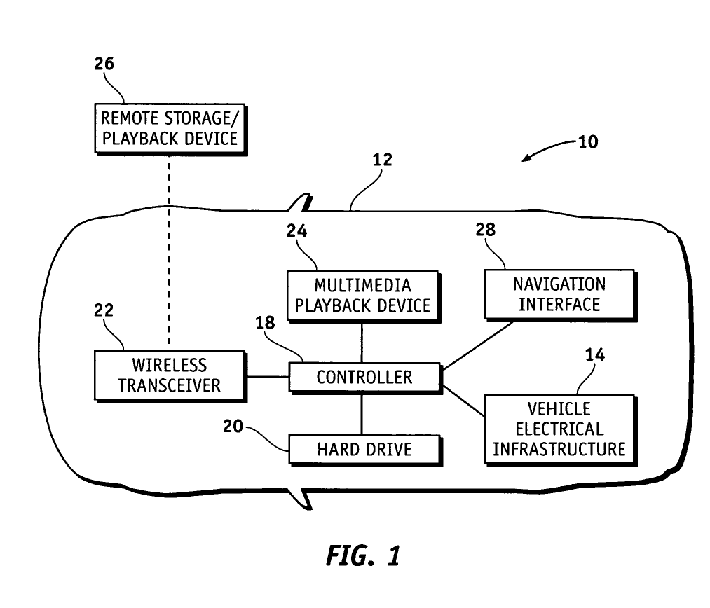

Referring to the drawings, FIG. 1 is a schematic diagram illustrating a first exemplary embodiment of a multimedia storage and transfer system 10 in a vehicle 12. In a more basic exemplary embodiment, the electronic vehicle storage system 10 includes a vehicle electrical infrastructure 14, a vehicle communications network 16 coupled to the vehicle electrical infrastructure 14, a controller 18 coupled to the vehicle electrical infrastructure 14, such as via the vehicle communications network 16, a navigation interface coupled to the controller 18, and a data storage device 20 coupled to the controller 18 and configured to store multimedia files. A wireless transceiver 22 and a multimedia playback device 24, described in greater detail hereinafter, may optionally be coupled to the controller 18.

The data storage device 20 and controller 18 are integrated with the vehicle 12. The controller 18 communicates with the vehicle electrical infrastructure 14, for example to receive current status information regarding various vehicle electrical systems/subsystems, as described in greater detail hereinafter. The data storage device 20 includes an embedded database containing a list of content that may be accessed by the controller 18 to associate a recognized multimedia file with a corresponding content from the list of content. Although one multimedia playback device 24 is shown in FIG. 1, a variety of multimedia storage/playback devices may be directly coupled to the electronic vehicle storage system 10, such as an in-dash radio receiver, a CD player, or a portable storage/playback device (e.g., MP3 player), via a universal serial bus (USB) connection, firewire, or other conventional one-way or two-way communication line. Additionally, a remote storage/playback device 26 may be wirelessly coupled with the electronic vehicle storage system 10 via the wireless transceiver 22, as described in greater detail hereinafter. The electronic vehicle storage system 10 provides a user with access to generally more audio or other multimedia content than found in conventional CD players.

As used herein, the term “file” refers to any data that is stored at one or more sources and is to be delivered as a unit to one or more destinations. For example, a document, an image, and a file from a file server or computer storage device, are all examples of “files” that may be delivered. Files can be of known size (such as a one megabyte image stored on a hard disk) or can be of unknown size (such as a file taken from the output of a streaming source).

The vehicle electrical infrastructure 14 may include various systems and/or subsystems on the vehicle 12, including by way of example and not of limitation a human vehicle interface, a battery power management system, an engine management system, a transmission management system, a body control module, and vehicle subsystems such as an antilock brake system (ABS). The data storage device 20 and controller 18 communicate over the vehicle communications network, such as controller area network (CAN) and J1850 type communication protocols, to transfer information to and from the vehicle systems and subsystems.

In one exemplary embodiment, the data storage device 20 is a hard disk drive, or hard drive, that has at least one platter/disk (not shown) accessed by a read/write head(s) (not shown) to transfer data from/to the platter/disk. The hard drive 20 stores a variety of data including, but not limited to, multimedia files, such as audio files, and a variety of status and diagnostic information from the various systems and subsystems of the vehicle 12, such as antilock brake system (ABS) status information. The hard drive 20 is located in the vehicle 12 and is wired to the vehicle electrical infrastructure 14, such as via the controller 18. Although the data storage device 20 is described herein in the context of a hard drive, a variety of other types of mass storage devices may also be used that have read/write capability.

As previously mentioned, the controller 18, such as a microprocessor or other conventional processing device, is coupled to the hard drive 20 to access information on the hard drive 20, direct transfer of information to/from the hard drive 20, and optionally communicate with various systems and/or subsystems on the vehicle 12. Although the controller 18 is shown as a separate device from the hard drive 20, the combined configuration of the controller 18 and hard drive 20 is not critical to the electronic vehicle storage system 10. For example, in another exemplary embodiment, the hard drive 20 incorporates the controller 18 such that the hard drive 20 and controller 18 is a single module.

The hard drive 20 may optionally communicate over a wireless network including, but not limited to, Wi-Fi, Bluetooth, a cellular network, or the like, to transfer information to and from remote systems, such as a key fob and a personal computer. One or more of a variety of networking or communication devices may be coupled with the controller 18. In one embodiment, the wireless transceiver 22 is coupled to the controller 18. A satellite receiver or telematics transceiver may also be coupled to the vehicle electrical infrastructure 14 and communicate with the controller 18.

For example, the hard drive 20 may communicate with a telematics provider, such as OnStar, to transfer information from a remote system using a cellular/satellite network and the Internet or other similar computer network. The particular wireless network or transceiver is not critical to the operation of the electronic vehicle storage system 10 provided each is compatible with the other. Those of skill in the art will appreciate that the wireless transceiver 22 may be embodied by one or more of a variety of different conventional wireless receivers, transmitters, and transceivers to transfer information between the hard drive 20 and a remotely located (i.e., external to the vehicle) multimedia storage system/device.

Each multimedia file has a corresponding multimedia file content. More than one multimedia file may be stored in a portable storage medium, stored in the hard drive 20, transferred to/from the wireless transceiver 22, or otherwise processed by the various components of the electronic vehicle storage system 10. Examples of conventional portable storage medium include, by way of example and not limitation, CD, digital video disc (DVD), read-only memory (ROM), programmable ROM types, random access memory (RAM), floppy disk, magnetic tape, flash memory, hard disk, and the like.

Content from a CD, such as an in-dash CD player coupled to the data storage device 20 or a CD drive integrated with the data storage device, may be transferred to the data storage device 20. For example, the user may insert a normal audio CD and copy content from the CD on to the data storage device 20. The controller 18 recognizes the content of the CD using the embedded database to associate the CD with a list of the content on the CD. If a CD is inserted into the system 10 that is not recognized by the controller 18, a telematics connection is established by the controller 18 via the wireless transceiver 22 to the remote storage/playback device (26), such as a remote server. Information regarding the inserted CD, such as genre, artist, album, are retrieved from a database on the server by the controller 18, downloaded to the hard drive 20, and stored with the embedded database. The embedded database may also be updated by receiving broadcast updates through the wireless transceiver 22 and downloading the updates to the hard drive 20. Content from a variety of other storage mediums may also be transferred to the hard drive 20, such as from a DVD player or an MP3 player.

In one exemplary embodiment, the multimedia content in the vehicle 12 is transferable to the remote data storage/playback device 26. The controller 18 selects a portion of the multimedia files stored in the hard drive 20 or all of the multimedia files stored therein for transfer via the wireless transceiver 22. The multimedia files are compressed and modulated into communication signals for transmission by the wireless transceiver 22 using conventional signal processing techniques, and the remote data storage device 26 receives such communication signals via a receiver (not shown), such as the wireless transceiver 22 of the multimedia storage and transfer system 10 associated with the originating vehicle 12.

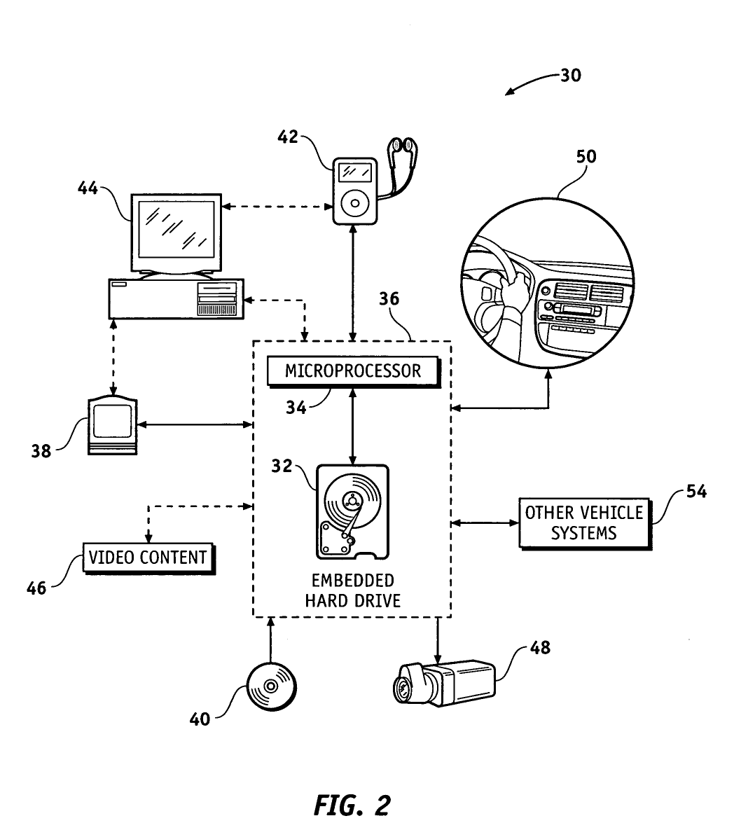

FIG. 2 is a block diagram illustrating communication between components of an electronic vehicle storage system 30. In this embodiment, the electronic vehicle storage system 30 includes, but is not limited to, a hard drive 32, such as the hard drive 20 shown in FIG. 1, a controller 34, such as the controller 18 shown in FIG. 1, coupled to the hard drive 32 and collectively referred to as a data storage device 36, a navigation interface 28 coupled to the data storage device 36, and the vehicle electrical infrastructure 14. Routing of communication from various components of the electronic vehicle storage system 30 to the data storage device 36 may vary between the hard drive 32 and the microprocessor 34.

For simplicity of explanation in this exemplary embodiment, communication from various components of the electronic vehicle storage system 30 to either the hard drive 32 and the controller 34 are described with respect to communication with the data storage device 36. For example, control signals may be communicated between the controller 34 and the wireless transceiver 22 shown in FIG. 1, and multimedia files may be wirelessly transferred from a personal computer 44 (PC) to the hard drive 32. In this example, such control signal communication and multimedia file transfer together establish communication between the data storage device 36 and the personal computer 44. The particular routing of communication among the hard drive 32, the controller 34, and other components of the electronic vehicle storage system 30 is not critical to the operation of the same.

The hard drive 32 has an embedded database containing a list of multimedia file content and stores multimedia files such as found on conventional CDs, DVDs, and other storage mediums. Multimedia files may be downloaded to the data storage device 36 from any number of devices. As best shown in FIG. 2, multimedia files may be downloaded to the data storage device 36 from a conventional CD 40, a compressed audio CD 38 that may be used to store compressed digital audio files such as MP3 files or the like, a portable storage/player device 42 such as a DVD player, a video content storage/player device 46 such as a digital video recorder (DVR), and a personal computer 44. In one exemplary embodiment, the multimedia files are stored as compressed files on the hard drive 32.

To preserve DRM protected multimedia files, a public key encoding system may be used to encrypt such multimedia files. For example, a vehicle identification number (VIN) may be used as the public key. In a wireless transfer configuration, the vehicle's public key may be transmitted over the wireless network to the remotely connected personal computer 44, portable storage/player device 42, video content storage/player device 46, or remote data storage device 26 (FIG. 1) to be used for encrypting content. For an end-to-end DRM scheme, the originating vehicle, such as the vehicle 12 shown in FIG. 1, may authenticate using the VIN as the public key before transfer of content thereto while also preserving DRM protected content from subsequent transfer out of the vehicle 12.

Wireless transfer of multimedia files is accomplished using a wireless transceiver such as the wireless transceiver 22 shown in FIG. 1. In one exemplary embodiment, content may be synchronized by the controller or microprocessor 34 between the electronic vehicle storage system 30 in the vehicle 12 (FIG. 1) and a remote storage/playback device 26 (FIG. 1) such as the home PC 44. For example, a music collection of audio files stored on the data storage device 36 may be synchronized with a music collection of audio files stored on the home PC 44. In this example, the microprocessor 34 may compare the content on the hard drive 32 with the content on the home PC 44 and transfer content acquired on the PC 44 to the vehicle 12 (FIG. 1). In this exemplary embodiment, content that may have been “ripped” from purchased CDs onto the hard drive 32 may be transferred from the PC 44 to the hard drive 32.

In one exemplary embodiment, the data storage device 36 has a port 41 for coupling the portable data storage device 42 to the data storage device 36. The port may be a universal serial bus (USB) port, firewire connection, or the like. In this embodiment, the microprocessor 34 is configured to transfer public key encoded multimedia files from the hard drive 32 to the portable data storage device 42 via said USB connection 41. Retrieval of the multimedia files on the portable data storage device 42 is restricted to access using the public key by the originating vehicle of the public key encoded multimedia files, such as the originating vehicle 12 shown in FIG. 1.

Being coupled with other vehicle systems 14, the data storage device 36 may record diagnostic and status information to the hard drive 32 to record vehicle operation states as time passes. This embodiment is particularly useful as an automotive “black box” where the data storage device 36 may be recovered in the event of a crash of the vehicle 12 (FIG. 1). The status information of various vehicle systems 54 stored in the data storage device 36 may be used to determine information about the crash. Additionally, the data storage device 36 may record diagnostic information relevant to the vehicle history and service to the hard drive 32. This information may be used by service professionals when repairing or performing maintenance on the vehicle 12 (FIG. 1).

The user interface 28, or navigation interface, displays the contents of the multimedia files stored on the hard drive 32, such as a music library, in the vehicle 12 (FIG. 1) and provides navigation (e.g., using a rotating knob, a push button, or touch-sensitive screen) among the multimedia files. In one exemplary embodiment, the user interface 28 has controls to rip/copy an entire CD (compressed or normal), DVD, or other portable storage medium to the hard drive 34. In another exemplary embodiment, the user interface 28 has controls to rip/copy specific tracks or files contained on the CD, DVD, or other portable storage medium. For example, during playback of the portable storage medium, the user may select a currently played track or file for ripping/copying to the hard drive 34. Additionally, the user interface 28 may provide a control to delete the currently played track or file from the hard drive 34. The user interface 28 displays the specific tracks or files that have been ripped/copied to the hard drive 34 from the portable storage medium. In this embodiment, the user has flexibility to selectively store and prune content recorded to the hard drive 34.

Rip or copy speed of multimedia files to the hard drive 34 may be limited due to shock and vibration while the vehicle 12 (FIG. 1) is in motion. In one exemplary embodiment, the hard drive 34 has a variable rip speed that dynamically adjusts based on vehicle movement. By coupling the microprocessor 36 to the various vehicle systems/subsystems, such as a body control module or throttle control module, the microprocessor 36 may increase or decrease rip speed based on status information communicated from such vehicle systems/subsystems. For example, the rip speed of the hard drive may be increase while the vehicle is not moving to maximize transfer time.

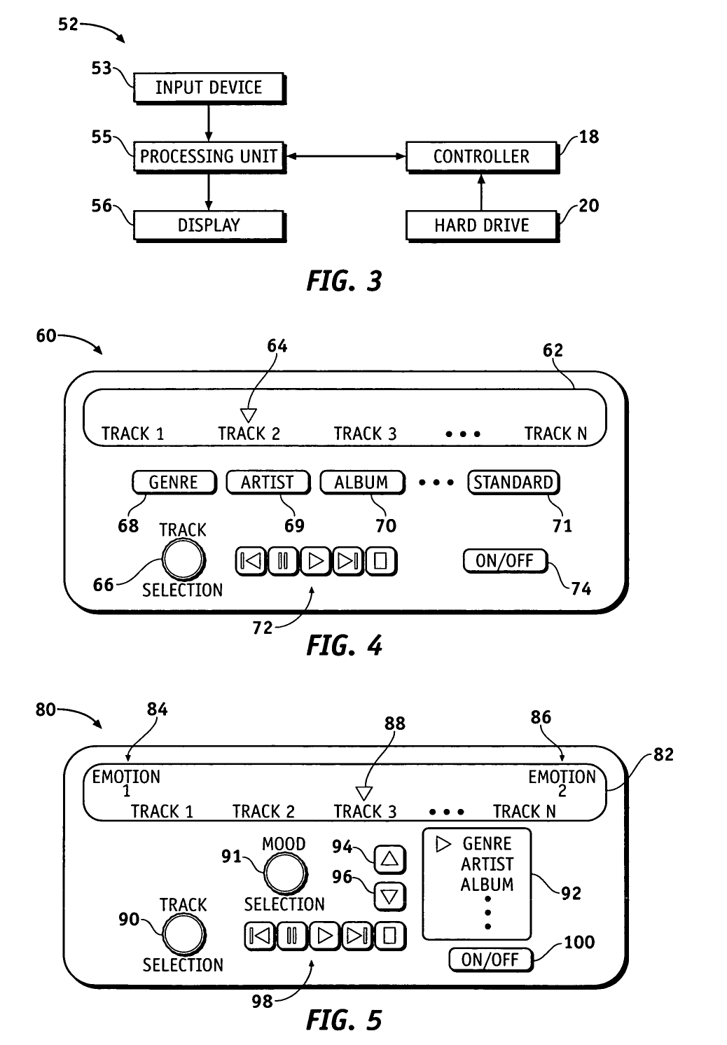

FIG. 3 is a block diagram of an exemplary embodiment of the navigation interface 28. The navigation interface 28 includes an input device 53, a processing unit 55 coupled to the input device 53, and a display coupled to the processing unit 55. In this exemplary embodiment, the processing unit 55 couples with the controller 18 (FIG. 1) to access multimedia files stored in the hard drive 20. Although the processing unit 55 is described in relation to a device separate from the controller 18 (FIG. 1), the processing unit 55 may be incorporated within the controller 18 as a single device in an alternative embodiment.

In one exemplary embodiment, the data storage device 36 monitors and determines listening habits of the user, such as by associating a multimedia file with a corresponding content or by monitoring and storing the playback frequency for the multimedia files stored in the embedded database. Based on the determined listening habits, the processing unit 55 generates a playlist so that browsing by the user to a particular content is not necessary. For example, the processing unit 55 retrieves the playback frequency for each of the multimedia files stored in the hard drive 20 and automatically generates a playlist of multimedia files based on the playback frequencies such that the multimedia files are sorted in the playlist from higher playback frequency to lower playback frequency.

The input unit 53 is configured to initiate playback of the playlist, such as by depressing a switch on the face of the navigation interface 28. During playback, the processing unit 55 communicates with the controller 18 to retrieve a currently selected multimedia file for playback via, for example, the multimedia playback device 24 (FIG. 1). For example, the processing unit 55 determines which multimedia file in the order of the playlist is to be retrieved from the hard drive 20 for playback. In this exemplary embodiment, a “one-touch” scheme is used to automatically generate the playlist and initiate playback of the multimedia files in the playlist, and the processing unit 55 automatically selects multimedia files from the playlist for playback based on the order of the playlist. The display 56 displays all of the multimedia files of the playlist and includes a symbol that indicates a multimedia file currently selected for playback. The entire contents of a music library corresponding to the playlist may be displayed such as on a display bar.

FIG. 4 is a front view of a first exemplary embodiment of the navigation interface 60. The navigation interface 60 includes, but is not limited to, a display bar 62, a pointer 64, playback content selection buttons 68, 69, 70, 71, a track selection controller 66 (e.g., a rotatable knob), playback mode buttons 72 (e.g., play, pause, stop, rewind, forward, and stop) for manipulating the playback of a currently selected multimedia file, and a on-off button 74 to activate/deactivate the navigation interface 60. In this exemplary embodiment, the processing unit 55 (FIG. 3) generates playlists (e.g., music libraries) for different playback contents such as a genre, an artist, and an album, as selected by activation of a genre mode button 58, an artist mode button 69, and an album mode button 70, respectively. A standard mode button 71 may be activated, such as by depressing the button 72, to instruct the processing unit 55 (FIG. 3) to generate the music library based on playback frequencies, as previously described herein. Other multimedia content categories may also be used, and the processing unit 55 may select multimedia files from the hard drive 20 (FIG. 3) to generate playlists that meet such multimedia content categories.

The display bar 62 shows the audio files of the music library corresponding to the selected playback content, or category of content, and the pointer 64 indicates a current position of playback within the music library (e.g., audio file currently selected for playback) along the display bar 62. The user can scroll through the audio files of the music library by rotating the track selection knob 66 counter-clockwise/clockwise and selecting an audio file for playback by depressing the track selection knob 66. A variety of other devices may be used to scroll through the music library and select an audio file for playback such as scroll-up/scroll-down buttons.

In addition to listing the audio files of the music library for the selected playback content, the audio files of the music library may be indicated along the display bar 62 by genres, artists, albums, etc. A softkey may also be used to “jump” to a specific place along the display bar 62. Although the user interface 28 is described herein with regard to the music library, a general multimedia library may also be displayed for navigation. For example, a video system 48 (FIG. 2) may be coupled to the data storage device 36 (FIG. 2) and include a monitor and related electronics to display video images such as from content associated with a DVD.

FIG. 5 is a front view of a second exemplary embodiment of the navigation interface 80. The navigation interface 80 includes, but is not limited to, a display bar 82, a pointer 88, a content display 92, playback content selection buttons 94, 96, a track selection controller 90 (e.g., a rotatable knob), a mood selection controller 91, playback mode buttons 98 (e.g., play, pause, stop, rewind, forward, and stop) for manipulating the playback of a currently selected multimedia file (e.g., audio file), and an on-off button 100 to activate/deactivate the navigation interface 80. In this exemplary embodiment, the content display 92 displays a variety of categories (e.g., genre, artist, album, mood, etc.) of content for playback selection. The content is browsed by scrolling up using the scroll-up button 94 and by scrolling down using the scroll-down button 96, and selection of the content for playback may is initiated such as by pressing the play button.

In this exemplary embodiment, the processing unit 55 (FIG. 3) generates a music library on the display bar 86 based on a selected mood via the mood selection controller 91. The processing unit 55 may generate a variety of mood continuums, each spanning from a first descriptive emotion 84 to a second descriptive emotion 86, for selection by the mood selection controller 91. The selected mood continuum is displayed on the display bar 82 with the first descriptive emotion 84 displayed at one end of the display bar 82 and the second descriptive emotion 86 displayed at the other end of the display bar 82. Examples of the mood continuums include, but are not limited to, “happy” to “sad” and “relaxing” to “exciting”. In one exemplary embodiment, the audio files may have pre-assigned moods such as may be based on the artist or genre associated with a particular multimedia file. In another exemplary embodiment, the user may assign a mood to the audio file, such as via the mood selection controller 91.

For each of the mood continuums, the processing unit 55 selects audio files from the hard drive 20 (FIG. 3) that fall within the mood continuum to generate a music library. For example, a “happy” emotion may have an assigned mood weight of 1, and a “sad” emotion may have an assigned mood weight of 10. Each of the audio files stored on the hard drive 20 (FIG. 3) may have an assigned mood weight, and the processing unit 55 selects audio files from the hard drive 20 (FIG. 3) having mood weights within the range of 1 to 10 and disregards audio files having mood weights outside of this range. The selected audio files are ordered by the processing unit 55 based on the mood weights from mood weight 1 to mood weight 10 to correspond with the displayed mood continuum.

The pointer 88 is moved along the mood continuum using the track selection controller 90 to select an audio file for playback having a mood corresponding to the position of the pointer 88 on the mood continuum. Playback of the generated music library for the selected mood continuum may proceed automatically from one of the descriptive emotions of the selected mood continuum to the other descriptive emotion of the selected mood continuum.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. In a vehicle multimedia system having an embedded database of multimedia files, a navigation interface for controlling playback of the multimedia files, the navigation interface comprising:
a processing unit configured to:
couple with the embedded database;
determine a playback frequency for each of the multimedia files; and
generate a playlist of multimedia files based on said playback frequency;
an input unit coupled to said processing unit and configured to initiate playback of said playlist of multimedia files; and
a display coupled to said processing unit and configured to display said playlist of multimedia files.

2. A navigation interface according to claim 1, wherein said processing unit is configured to sequentially select a multimedia file from the embedded database for playback based on said playlist of multimedia files; and
wherein said display is configured to display said multimedia file selected by said processing unit for playback.

3. A navigation interface according to claim 1, wherein said processing unit is further configured to:
sequentially select a multimedia file from the embedded database for playback based on said playlist of multimedia files; and
generate a symbol on said display, said symbol configured to indicate said multimedia file selected by said processing unit for playback in said playlist of multimedia files displayed by said display.

4. A navigation interface according to claim 2, wherein said input unit further comprises a controller configured to scroll through said playlist of multimedia files and further configured to select a multimedia file from said playlist of multimedia files for playback.

5. A navigation interface according to claim 4, wherein said processing unit is further configured to detect said multimedia file selected by said controller for playback; and
wherein said display is further configured to display said multimedia file selected by said controller for playback.

6. In a vehicle multimedia system having an embedded database of multimedia files, a navigation interface for controlling playback of the multimedia files, the navigation interface comprising:
an input unit configured to select a category of multimedia content;
a processing unit coupled to said input unit and configured to:
detect a selected category of multimedia content;
couple with the embedded database; and
generate a playlist of multimedia files from the embedded database based on said selected category of multimedia content, said input unit further configured to initiate playback of said playlist of multimedia files; and
a display coupled to said processing unit and configured to display said playlist of multimedia files and said selected category of multimedia content.

7. A navigation interface according to claim 6, wherein said processing unit is further configured to generate at least one category of multimedia content on said display.

8. A navigation interface according to claim 7, wherein said at least one category is selected from a genre, an artist, and an album.

9. A navigation interface according to claim 7, wherein said processing unit is further configured to:
generate at least one subcategory of multimedia content on said display for said at least one category of multimedia content; and
generate said playlist based on said at least one subcategory of multimedia content.

10. A navigation interface according to claim 6, wherein said processing unit is configured to sequentially select a multimedia file from the embedded database for playback based on said playlist of multimedia files; and
wherein said display is configured to display said multimedia file selected by said processing unit for playback.

11. A navigation interface according to claim 6, wherein said input unit further comprises a controller configured to scroll through said playlist of multimedia files and further configured to select a multimedia file from said playlist of multimedia files for playback.

12. A navigation interface according to claim 11, wherein said processing unit is further configured to detect said multimedia file selected by said controller for playback; and
wherein said display is further configured to display said multimedia file selected by said controller for playback.

13. A vehicle multimedia system comprising:
a database of multimedia files;
an input unit configured to select a category of multimedia content;
a processing unit coupled to said input unit and said database, said processing unit configured to:
generate at least one category of multimedia content;
detect a selected category of multimedia content; and
select a group of multimedia files for playback from said database of multimedia files based on said selected category of multimedia content; and
a display coupled to said processing unit and configured to display said at least one category of multimedia content and said selected category of multimedia content.

14. A vehicle multimedia system according to claim 13, wherein said processing unit is further configured to generate a continuum between a first mood and a second mood; and
wherein said display is further configured to display said first mood, said second mood, and said continuum between said first mood and said second mood.

15. A vehicle multimedia system according to claim 14, wherein said first mood has a first mood weight, said second mood has a second mood weight, and each of the multimedia files of said database has a mood weight; and
wherein said processing unit is further configured to:
select said group of multimedia files having mood weights between said first mood weight and said second mood weight from said database of multimedia files; and
sort said group of multimedia files into said continuum from said first mood weight to said second mood weight.

16. A vehicle multimedia system according to claim 15, wherein each of the multimedia files of said group of multimedia files has an artist and a genre; and wherein said mood weight of each of said multimedia files of said group of multimedia files is based on at least one of said artist and said genre.

17. A vehicle multimedia system according to claim 15, wherein said input unit further comprises a controller configured to assign a mood weight to a multimedia file in said database of multimedia files.

18. A vehicle multimedia system according to claim 14, wherein said input unit further comprises a controller configured to scroll through said continuum between said first mood and said second mood and further configured to select a position in said continuum for playback.

19. A vehicle multimedia system according to claim 18, wherein said processing unit is further configured to select a multimedia file from said group of multimedia files for playback based on said position selected by said controller; and
wherein said display is further configured to display said multimedia file selected by said processing unit for playback.

20. A vehicle multimedia system according to claim 13, wherein said database is an embedded database.
